(19) United States
(12) Patent Application Publication
(10) Pub. No.: US 2011/0297196 A1
(43) Pub. Date: Dec. 8, 2011

(54) HINGE JOINT ASSEMBLY

(75) Inventor: Michael Durante, Bronte (AU)

(73) Assignee: Basil Bangs Pty Ltd., Bondi (AU)

(21) Appl. No.: 13/153,079

(22) Filed: Jun. 3, 2011

(30) Foreign Application Priority Data
Jun. 3, 2010 (AU) 2010902434

(51) Int. Cl. A45B 25/02; E05F 1/12; E05D 11/10

(52) U.S. Cl. 135/15.1; 16/319; 16/297

(57) ABSTRACT

A hinge joint assembly including a first body having a first circular serrated edge located around a first central axis; a second body having a second circular serrated edge located around a second central axis, said second circular serrated edge corresponding with and adapted to engage with the first circular serrated edge; an axle rod, extending through the first central axis and the second central axis, adapted to enable the first and second bodies to rotate relative to one another; biasing means, positioned between the first body and the second body, for biasing said first and second bodies away from each other along the axle rod; movement limiting means for preventing the second body from being separated from the first body beyond a pre-determined distance; and a cam element, rotatable about the axle rod, adapted to move the second body relative to the first body, from a joint locked position to a joint unlocked position.

The present application claims priority under 35 U.S.C §. 119 to Australian provisional patent application no. 2010902434 which was filed on 3 Jun. 2010, which is hereby incorporated by reference in its entirety.

### FIELD OF THE INVENTION

The present invention relates to hinge joints adapted to be rotated and to be, selectively, locked into one of two or more desired orientations. The present invention has particular application in relation to articles such as outdoor umbrellas, lamp stands, computer monitor extension arms and similar items for which it is often desirable to have two or more arms or legs rotatable relative to one another and lockable in a number of different orientations.

### BACKGROUND OF THE INVENTION

Numerous different types of hinge joints are known and a number of these do have the ability to enable the joints to be rotated and locked into a number of selected orientations. Such hinge joints find use in numerous applications, including outdoor umbrellas, lamp stands, computer monitor extension arms and other such articles.

For example, in the 1960's and 70's (and afterwards), many beach umbrellas were typically formed with metallic hinge joints which enabled two adjoining arms of the beach umbrella to be rotated and locked into a number of different orientations (as desired by the user). This had the benefit of enabling the canopy portion of the umbrella to be tilted so as to provide optimum shade depending on the position of the sun. These hinge joints typically included of two rounded heads, each of which had opposed faces incorporating corresponding circular serrated surfaces. These circular heads were held together by a bolt and wing nut arrangement, wherein the bolt extended through a central opening in each of the circular heads and the circular heads were releasably held together by screwing the wing nut tightly onto the bolt. Each of the circular heads was connected to an arm (or leg) of the umbrella. The orientation of the two arms (or legs) could be varied by unscrewing and loosening the wing nut and then rotating one of the arms (or legs) relative to the other. The desired orientation of the two arms (or legs) could then be fixed by tightening the wing nut which caused the opposed serrated surfaces to engage with one another, thereby maintaining the hinge joint in a locked orientation.

Beach umbrellas such as those described above had numerous limitations. For instance, the loosening and/or tightening of the nut on the bolt was a rather awkward, inconvenient and often frustrating exercise. Typically, the nut would need to be rotated through multiple rotations in order to sufficiently loosen or tighten the circular heads for the hinge to be moved or locked into position. This process took considerable time and this could have adverse consequences, particularly if there was a strong wind blowing or if rotation and securing of the umbrella arms was needed to be effected quickly. Also, when loosening the nut, if the nut was rotated too many times, it could fall off the end of the bolt. If this occurred, the two arms of the umbrella could readily become disengaged and it then would become even more awkward to reconnect the arms and to position them in the desired orientation. A further problem with this was that, if the nut did become disconnected from the bolt, it could fall on the ground (which may be grass or sand) causing the nut to become lost.

Other hinge joints for outdoor umbrellas are known but most of these only allow for moving and locking the arms in a very limited number of predetermined orientations.

For instance, U.S. Pat. No. 3,489,157 describes a tiltable beach umbrella having two arms which are hinged together. The hinge joint described in this US patent also has a number of limitations. In particular, the hinge joint only enables rotation and locking of the joint in a very limited number of positions. Further, the invention described in U.S. Pat. No. 3,489,157 describes an arrangement in which the tilting of the movable arm of the umbrella is caused by the winding up of a nylon cord. This arrangement lacks the strength which is desirable in such hinge arrangements and it is also cumbersome and difficult to use.

Other lockable hinge joints are also known which have applications beyond the outdoor umbrella field. For instance, U.S. Pat. No. 3,849,834 describes a lockable hinge joint having two arms which are rotatable about a common axis and in which the hinge joint is lockable in at least one predetermined position. The hinge joint described in U.S. Pat. No. 3,849,834 is quite a complex arrangement which incorporates a locking ratchet adapted to engage locking detentes formed on a peripheral edge of the locking arms. The ratchet incorporates a type of piston which, under the influence of a spring, tensions the piston towards and into the locking detentes. In order to release the piston from the locking detense, a release lever is incorporated into the assembly. The invention described in U.S. Pat. No. 3,849,834 is quite a complex arrangement which would be relatively difficult and expensive to manufacture. Furthermore, the invention described in this US patent suffers from the deficiency of only having a very limited number of locking detentes and therefore a correspondingly limited number of orientations in which the relevant arms can be positioned.

Any reference herein to known prior art does not, unless the contrary indication appears, constitute an admission that such prior art is commonly known by those skilled in the art to which the invention relates, at the priority date of this application.

### SUMMARY OF THE INVENTION

According to a first aspect of the present invention, there is provided a hinge joint assembly including:
a first body having a first circular serrated edge located around a first central axis;
a second body having a second circular serrated edge located around a second central axis, said second circular serrated edge corresponding with and adapted to engage with the first circular serrated edge;
an axle rod, extending through the first central axis and the second central axis, adapted to enable the first and second bodies to rotate relative to one another;
biasing means, positioned between the first body and the second body, for biasing said first and second bodies away from each other along the axle rod;
movement limiting means for preventing the second body from being separated from the first body, under the influence of the biasing means, beyond a pre-determined distance; and
a cam element, rotatable about the axle rod, adapted to move the second body relative to the first body, from a joint locked position to a joint unlocked position, as the m element is rotated from a first angular position to a second angular position.

Preferably, each of the first and second circular serrated edges comprise a plurality of teeth of substantially uniform height and dimensions and the pre-determined distance is no less than the height of the teeth. Generally, a large number of small teeth will be preferred over a small number of larger teeth as this will facilitate easy engagement of the opposed first and second serrated edges. It will also enable the first and second bodies of the hinge joint assembly to be locked in a significantly greater number of optional angle orientations. A large number of smaller teeth will also, generally, be more convenient to use as, in such an embodiment, the first and second bodies will not need to be separated very far in order to enable them to move between the joint locked position and the joint unlocked position. As will be appreciated, however, if the teeth are too small, this may compromise the security of the hinge joint assembly when in the joint locked position.

In a preferred embodiment of this invention, the axle rod is fixedly secured to the first body and the second body is rotatable about the axle rod. The axle rod may, therefore, be integrally formed with the first body or, alternatively, it may be securely fastened to the first body.

In a particularly preferred embodiment of the invention:
the second body comprises an inner face facing towards the first body and an outer face facing away from the first body;
the cam element comprises a cam face which abuts the outer face of the second body;
at least one of the outer face and the cam face has an inclined surface; and
the outer face and the cam face are adapted to cause the second body to move relative to the first body as the cam element is rotated relative to the second body.

In order to achieve this relative movement of the first and second bodies, the cam face may include a protrusion extending outwardly from the cam face and the outer face of the second body may comprise a ramped surface which inclines between a first point and a second point angularly separated from the first point. In this embodiment, as the cam element is rotated in a given direction (e.g. clockwise), the protrusion on the cam face presses against the ramped surface of the second body, causing the second body to move along the axle rod towards the first body. When the cam is rotated in an opposite direction (e.g. counter-clockwise), the second body, under the influence of the biasing means, moves away from the first body, thereby disengaging the first and second circular serrated edges and enabling the first body and the second body to rotate relative to one another.

Alternatively, both the cam face and the outer face of the second body may comprise ramped surfaces, which incline between a first point and a second point on each face, each of said second points being angularly separated from the corresponding first point. In this embodiment, as the cam element is rotated, the ramped surface on the cam face presses against the ramped surface on the outer face of the second body, causing the second body to move along the axle rod, either towards or away from the first body, depending upon the direction of rotation of the cam element.

As will be appreciated, the height differential between the abovementioned, angularly separated first and second points, will be substantially equivalent to the pre-determined distance. Accordingly, as the cam element is rotated from the first angular position to the second angular position, the cam face and the outer face rotate relative to one another and the ramped surface (or surfaces) thereby cause the second body to move the pre-determined distance along the axle rod.

The movement limiting means typically comprises a protruding element extending from the axle rod adjacent a free end of the axle rod. This protruding element may be a circlip, an inner edge of which is seated in a groove about the circumference of the axle rod adjacent to the cam element.

In a preferred alternative embodiment, the free end of the axle rod is threaded and the protruding element is a nut, such as a lock nut, located about the threaded free end of the axle rod.

It is preferable that a washer is positioned between the circlip and the cam element. In the preferred embodiment in which the protruding element is a nut located about the threaded free end of the axle rod, the washer includes an inner circumference and an outer circumference, said inner circumference having a small nipple protruding inwardly from the inner circumference. In this preferred embodiment, the free end of the axle rod includes a longitudinal groove adapted to receive the nipple of the washer. The positioning of the nipple of the washer in the groove of the axle rod inhibits any rotation of the washer and, consequently, the nut.

In a particularly preferred embodiment of this invention, the first body comprises a circular base portion and a first circular flange extending upwardly from a perimeter of the circular base portion. In this embodiment, the first circular serrated ridge is preferably located on an inner wall of said first circular flange. Consequently, when the second circular serrated ridge is engaged with the first circular serrated ridge, the second circular serrated ridge is typically located within said first circular flange.

Preferably, the cam element also includes an operational face having finger engagement means for facilitating a user's fingers to engage therewith in order to rotate the cam. The finger engagement means may be any suitable arrangement which makes it convenient for a user to rotate the cam element.

In a further preferred embodiment of the invention, the second body comprises a second circular flange extending upwardly from a perimeter of the outer face and the cam element is located within a cavity defined by the outer face and the second circular flange.

The biasing means may be any suitable biasing means for performing the biasing function mentioned above. Preferably, the biasing means will be a spring, such as a coil spring. It is further preferred that the coil spring is positioned around the axle rod. Typically, a first end of the coil spring abuts the circular base portion of the first body and a second end of the spring abuts the inner face of the second body. In order to inhibit possible wear and tear between the ends of the spring and the adjoining faces of the first and second bodies, washers (such as plastic or rubber washers) or similar items may be interposed between the ends of the spring and the adjoining faces.

The second body may further include a cylindrical sleeve extending from the inner face adjacent the second central axis, said cylindrical sleeve being located about said axle rod. Further, the hinge joint assembly may also include a bush piece positioned intermediate the axle rod and the cylindrical sleeve. The main purposes of the cylindrical sleeve and the bush piece are to minimise any ‘rattle’ between the first body and the second body and to ensure smooth in and out movement of the second body relative to the first body when moving between the joint locked position and the joint unlocked position. The dimensions of the bush piece can be altered to adjust the ‘tightness’ of the hinge joint assembly.

As noted above, the axle rod is preferably fixedly secured to the first body. This can be achieved in a number of ways. In one preferred embodiment, the axle rod is secured to the first body by being molded into said first body. Alternatively, the axle rod may be secured to the first body by means of axle rod affixing means, such as a mounting sleeve extending axially from the circular base portion of the first body, said mounting sleeve being adapted to receive a securing end of the axle rod. The securing end of the axle rod is typically securely affixed within the mounting sleeve by means of an interference fit. This interference fit may be achieved by the diameter of the axle rod being slightly larger (e.g. 8.12 mm) than the diameter of the internal cavity of the mounting sleeve (e.g. 8.00 mm). Alternatively, the free end of the axle rod and an internal wall of the mounting sleeve may have co-operating threads and the axle rod may be secured to the first body by screwing the free end of the axle rod into the mounting sleeve. Another alternative for securing the axle rod to the first body is by inserting the free end of the axle rod into the mounting sleeve and holding it in place by means of a strong adhesive. In these embodiments, the bush piece is typically positioned intermediate the mounting sleeve of the first body and the cylindrical sleeve of the second body.

The free end of the axle rod is typically covered by a cap. A functional benefit of the cap is that it inhibits dirt, dust, sand, grime, water or other foreign matter from entering the hinge joint assembly. The cap is also desirable for aesthetic reasons as it covers from view the free end of the axle rod.

Preferably, the first body of the hinge joint assembly includes first connection means for joining said first body to a first object and the second body includes second connection means for joining said second body to a second object. These first and second objects may be the trunk sections of an outdoor umbrella. Alternatively, as will readily be appreciated, these first and second objects may be any other objects which are to be rotated between two or more different positions and selectively locked in these positions. Other such examples include the arms and/or legs of lamps, lamp stands, computer monitor extension arms and the like.

As will be appreciated, the abovementioned hinge joint assembly provides a quick locking and/or quick release mechanism. The hinge joint assembly is adapted to be, selectively, locked or unlocked very quickly and easily, simply by rotating the cam element in the relevant direction.

According to another aspect of the present invention, there is provided a bendable article comprising a first arm, a second arm and a hinge joint assembly according to the first aspect of the invention described above, said hinge joint assembly being positioned between and connected to said first and second arms. In a particularly preferred embodiment of this aspect of the invention, the bendable article is an outdoor umbrella.

According to a further aspect of this invention, there is provided an outdoor umbrella, comprising a trunk leg, a movable arm and a hinge joint assembly according to the first aspect of the invention described above, wherein said hinge joint assembly is positioned between and connected to the trunk leg and the moveable arm.

Preferably, a free end of the trunk leg comprises ground engaging means. This ground engaging means may comprise a metal tip having a sharpened end and an external threaded surface extending from the sharpened end.

### BRIEF DESCRIPTION OF THE DRAWINGS

An embodiment or embodiments of the present invention will now be described, by way of example only, with reference to the accompanying drawings, in which:

FIG. 1 is an exploded front perspective view of a hinge joint assembly according to a preferred embodiment of the present invention;

FIG. 1A is an exploded rear perspective view of the hinge joint assembly shown in FIG. 1;

FIG. 2 is an exploded front perspective view of a hinge joint assembly according to an alternative preferred embodiment of the present invention;

FIG. 2A is an exploded rear perspective view of the hinge joint assembly shown in FIG. 2;

FIG. 3 is another exploded front perspective view of the hinge joint assembly according to a preferred embodiment of the present invention.

FIG. 4 is a front perspective view of a first body and an axle rod prior to attachment to the first body, according the embodiment of the invention shown in FIG. 3.

FIG. 5 is a front cross-sectional view of the first body shown in FIG. 4, with the axle rod attached thereto.

FIG. 6 is a front perspective view of the first body shown in FIG. 4, with the axle rod attached and showing a bush piece prior to attachment to the first body.

FIG. 7 is a front perspective view of the first body shown ion FIG. 4, including the axle rod and the bush piece attached thereto, with a coil spring located about the axle rod, and a second body prior to attachment to the first body.

FIG. 8 is a front perspective view of the first body and the second body shown in FIG. 7, engaged with one another, and the cam element prior to attachment to the second body.

FIGS. 9a and 9b are two representations showing the cam element attached to the second body shown in FIG. 7.

FIG. 10 is a top perspective view of the first body and the second body shown in FIG. 8 and the cam element attached to the second body, with a circlip about to be installed on a free end of the axle rod.

FIG. 11 is a top perspective view of the first body, the second body and the cam element shown in FIG. 10, with circlip installed, and with a cap about to be installed over the free end of the axle rod.

FIGS. 12a and 12b are cross-sectional views of the hinge joint assembly according to a preferred embodiment of this invention in a locked position.

FIGS. 13a and 13b are cross-sectional views of the hinge joint assembly shown in FIGS. 12a and 12b but in the open position.

FIGS. 14a and 14b are side views of an outdoor umbrella, incorporating a hinge joint assembly of this invention, in an upright and a tilted orientation.

### DETAILED DESCRIPTION OF THE EMBODIMENT OR EMBODIMENTS

A description of the embodiment or embodiments of the present invention, as illustrated in the abovementioned drawings, is provided below.

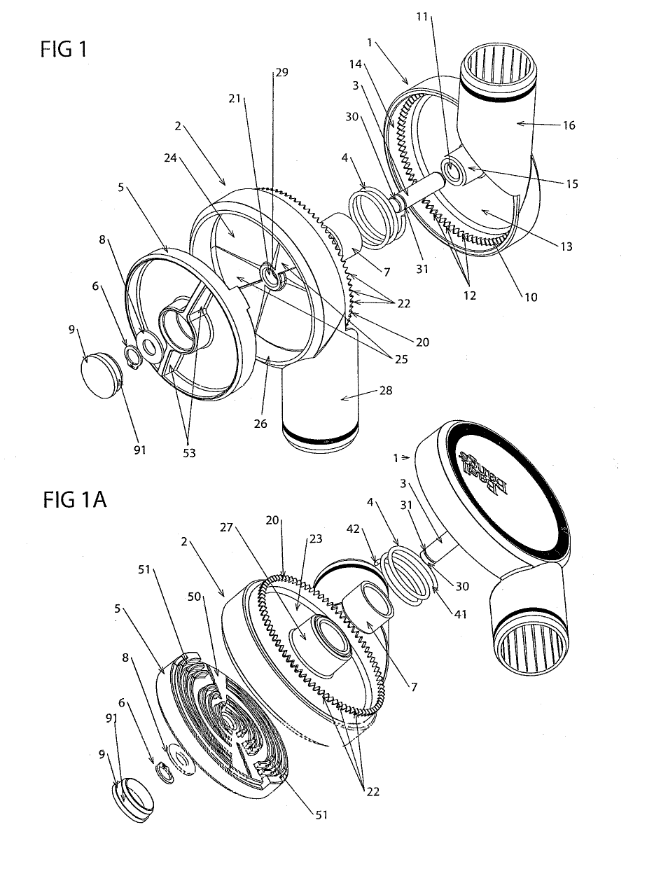

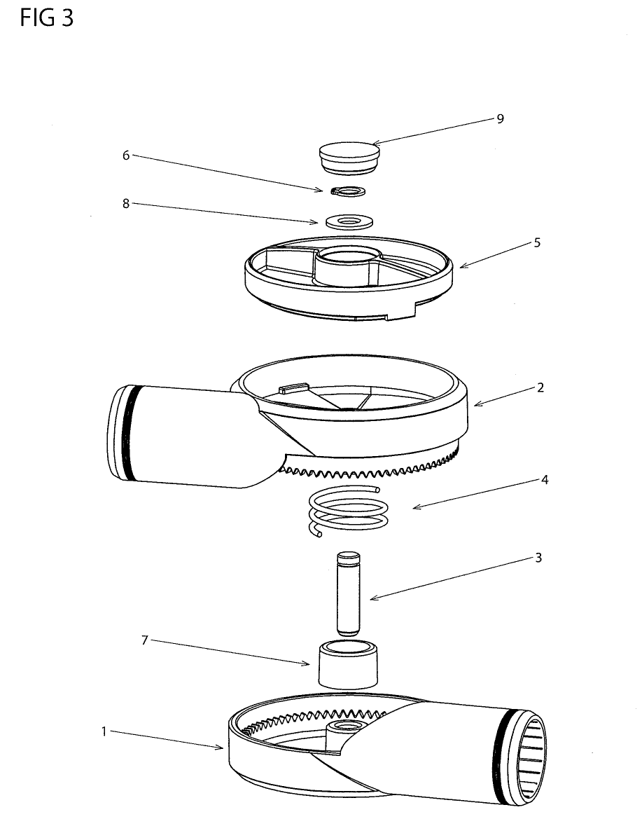

As can be seen from FIGS. 1, 1A and 3, the hinge joint assembly according to a preferred embodiment of this invention includes a number of components, including a first body 1, a second body 2, an axle rod 3, a coil spring 4, a cam element 5, a circlip 6, a bush piece 7, a washer 8, and a cap 9.

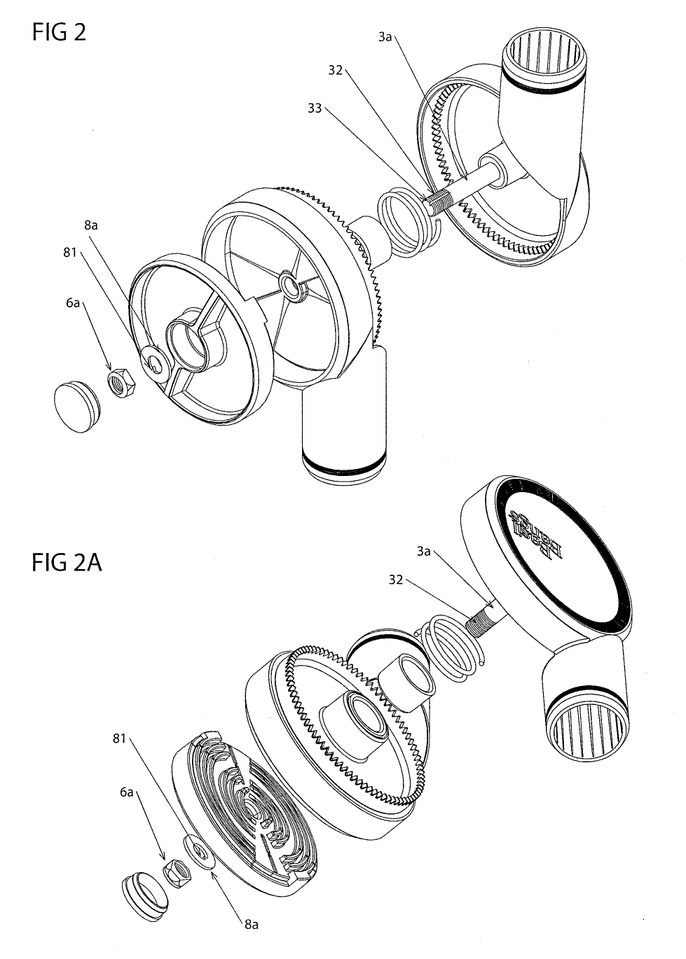

FIGS. 2 and 2A show an alternative preferred embodiment which is largely the same as the preferred embodiment shown in FIGS. 1 and 1A. The only real differences in the alternative preferred embodiment of FIGS. 2 and 2A are the following:
the circlip 6 (of FIGS. 1 and 1A) has been replaced by a lock nut 6a;
the washer 8 (of FIGS. 1 and 1A) has been replaced by a washer 8a which includes a nipple 81 protruding from an inner circumference of the washer 8a;
the axle rod 3a (of FIGS. 2 and 2A) is molded into first body 1;
a free end of the axle rod 3a (of FIGS. 2 and 2A) includes a threaded section 32 which is adapted to engage with a corresponding threaded surface within the lock nut 6a; and
the threaded section 32 of the axle rod 3a (of FIGS. 2 and 2A) includes a longitudinal groove 33 which is adapted to receive the nipple 81 of the washer 8a.

The first body 1 incorporates a circular base portion 13 and a first circular flange 14 extending upwardly from a perimeter of the circular base portion 13. The first body 1 also includes a first circular serrated edge 10 positioned adjacent an inner wall of the first circular flange 14. The first circular serrated edge 10 includes a multitude of substantially v-shaped teeth 12.

In the preferred embodiment shown in FIGS. 1 and 1A, the first body 1 further includes a mounting sleeve 15 located about a first central access 11 of the first body 1.

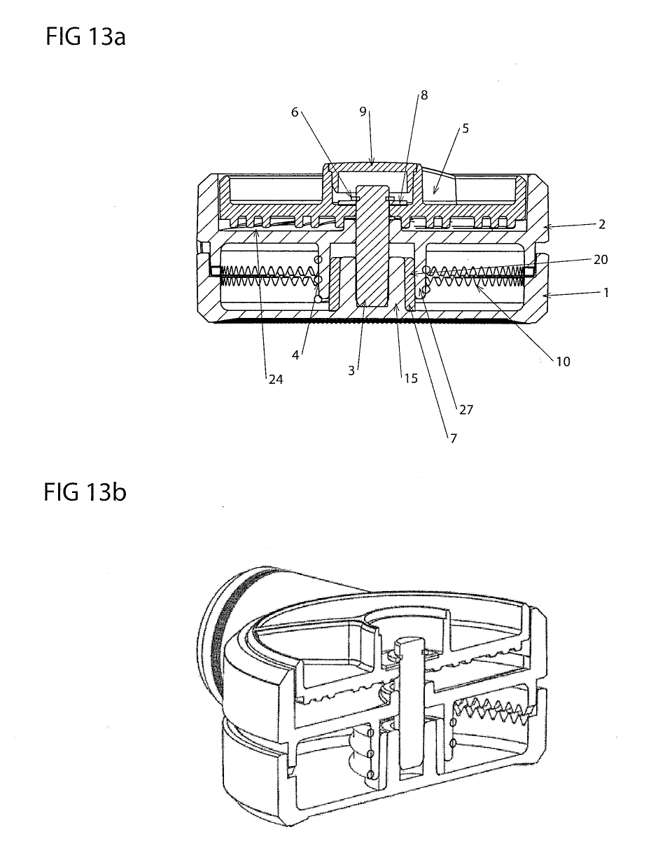

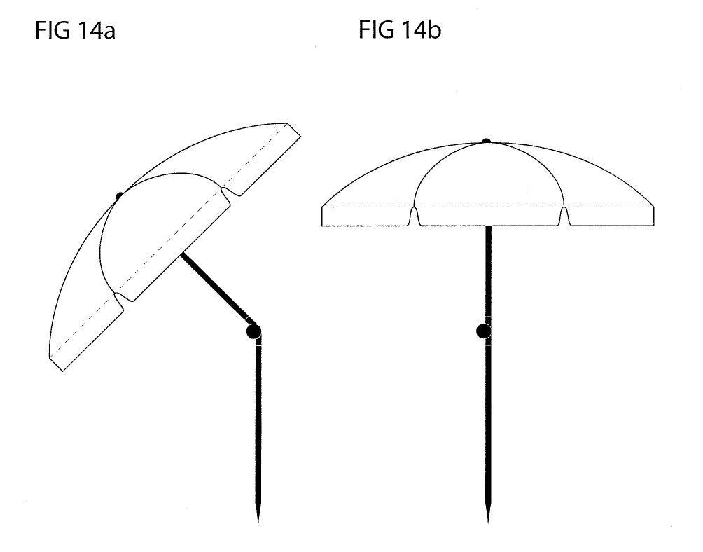

As better shown in FIGS. 5, 6, 7, 8, 12a, 12b, 13a and 13b, one end of the axle rod 3 is securely positioned within the mounting sleeve 15.

As shown in FIGS. 1, 1A, 2, 2A and 3, the second body 2 includes an inner face 23 and an outer face 24. The second body 2 includes a second circular serrated edge 20 located about a perimeter of the inner face 23.

The second body 2 also includes a cylindrical sleeve 27, located about the second central access 21 and which also extends upwardly from the inner face 23. The second circular serrated edge 20 incorporates a multitude of substantially v-shaped teeth 22.

The outer face 24 of the second body 2 (best shown in FIGS. 1 and 2) includes inclined surface sections 25. The second body 2 also includes a second circular flange 26 extending from a perimeter of the outer face 24.

As can also be seen from FIGS. 1A, 2A, and 3, the cam element 5 includes a cam face 50 and inclined surface elements 51 located on the cam face 50 (as best shown in FIGS. 1A and 2A).

The cam element 5 also includes an operational face 52 which includes protruding ribs 53 (as best shown in FIGS. 1 and 2) which are adapted to be engaged by the fingers of a user.

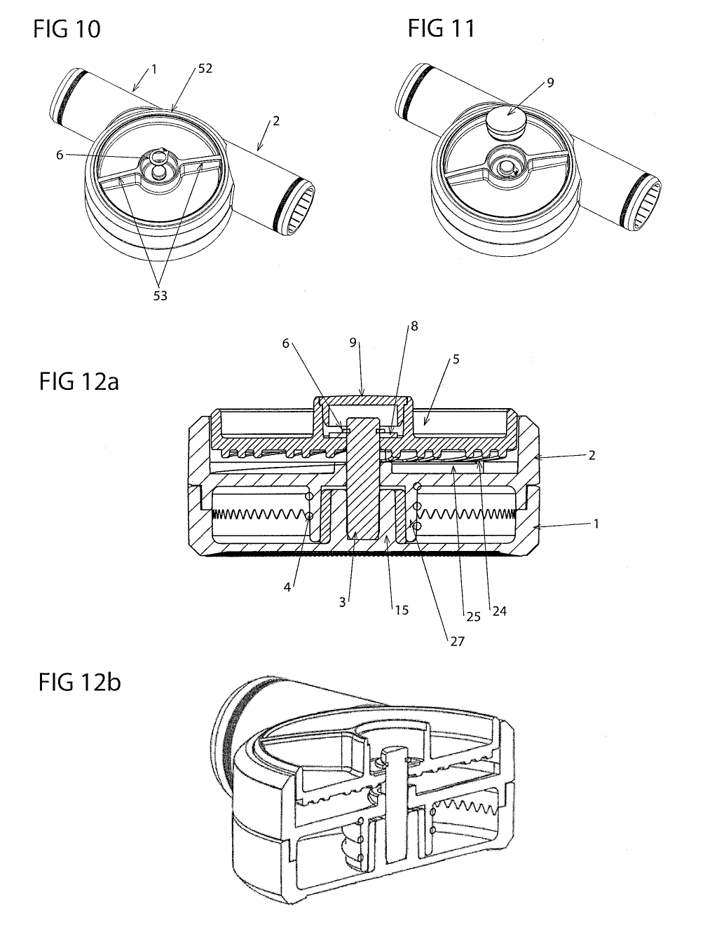

In the preferred embodiment shown in FIGS. 1 and 1A, the assembly also includes a circlip 6 a portion of which is seated within an annular groove 31 near the free end 30 of the axle rod 3. The location and positioning of the circlip 6 are best illustrated in FIGS. 10, 12a and 13a. A washer 8 is typically included between the circlip 6 and the cam element 5.

In the alternative preferred embodiment shown in FIGS. 2 and 2A, the assembly includes a lock nut 6a and the free end 30 of the axle rod 3a includes a threaded section 32 which is adapted to engage with a corresponding threaded section in the lock not 6a. The lock nut 6a is thereby able to be screwed onto the free end 30 of the axle rod 3a.

A washer 8a is typically included between the lock nut 6a and the cam element 5. This washer 8a includes a nipple 81 adapted to be received in a longitudinal groove 33 in the threaded section 32 of the axle rod 3a. The positioning of the nipple 81 in this groove 33 inhibits the washer from rotating relative to the cam element 5 and thereby inhibits the lock nut 6a from loosening as a result of rotation of the cam element 5.

The coil spring 4 is positioned in between the first body 1 and the second body 2. As best shown in FIGS. 7, 12a and 13a, the coil spring is positioned about the axle rod 3.

As best shown in FIGS. 6, 7, 12a and 13a, a bush piece 7 is positioned about the mounting sleeve 15 of the first body 1. When the second body 2 and the first body 1 are joined, the cylindrical sleeve 27 of the second body 2 is positioned around the bush piece 7 which itself surrounds the mounting sleeve 15 of the first body 1. This arrangement of the cylindrical sleeve 27, the bush piece 7 and the mounting sleeve 15 enables for a firm periscopic-type engagement with minimal rattle or shake between the various elements. The dimensions of the bush piece 7 can be varied in order to control or determine the tightness of this periscopic-type connection.

The second body 2 includes a centrally located body hole 29 adapted to enable the free end 30 of the axle rod 3 to pass therethrough.

Similarly, the cam element 5 also includes a centrally located cam hole 54. This cam hole 54 is also adapted to enable the free end 30 of the axle rod 3 to pass therethrough. The cam hole 54 is further adapted to house the washer 8 and the circlip 6 (or the lock nut 6a in the alternative preferred embodiment of FIGS. 2 and 2A).

The assembly illustrated in the drawings also includes a small cap 9 for covering the open end of the cam hole. This cap 9 may include a skirt 91 which fits inside the cam hole 54 and is held in place by means of a friction fit. This cap 9 inhibits dirt, dust, sand, grime, water and the like from entering into the assembly via the cam hole 54. The cap 9 also enhances the aesthetic finish of the assembly.

The first body 1 and the second body 2 each includes arm connection sleeves 16, 28, adapted to receive an end of a pole, arm, leg or other similar extension.

As can be seen from the drawings, the hinge joint assembly illustrated in the drawings can be constructed substantially in the following manner.

In the preferred embodiment shown in FIGS. 1 and 1A, a securing end 32 of the axle rod 3 is inserted (i.e. forced) into a hole defined by the mounting sleeve 15. The bush piece 7 is then positioned about the mounting sleeve 15. The coil spring 4 is then placed around the bush piece 7 such that a first end 40 of the coil spring 4 abuts the circular base portion 13 of the first body 1. The second body 2 is then brought towards the first body 1. The free end 30 of the axle rod 3 is passed through the second central access 21 of the second body 2 and the second circular serrated edge 20 of the second body 2 is caused to engage with the first circular serrated edge 10 of the first body 1.

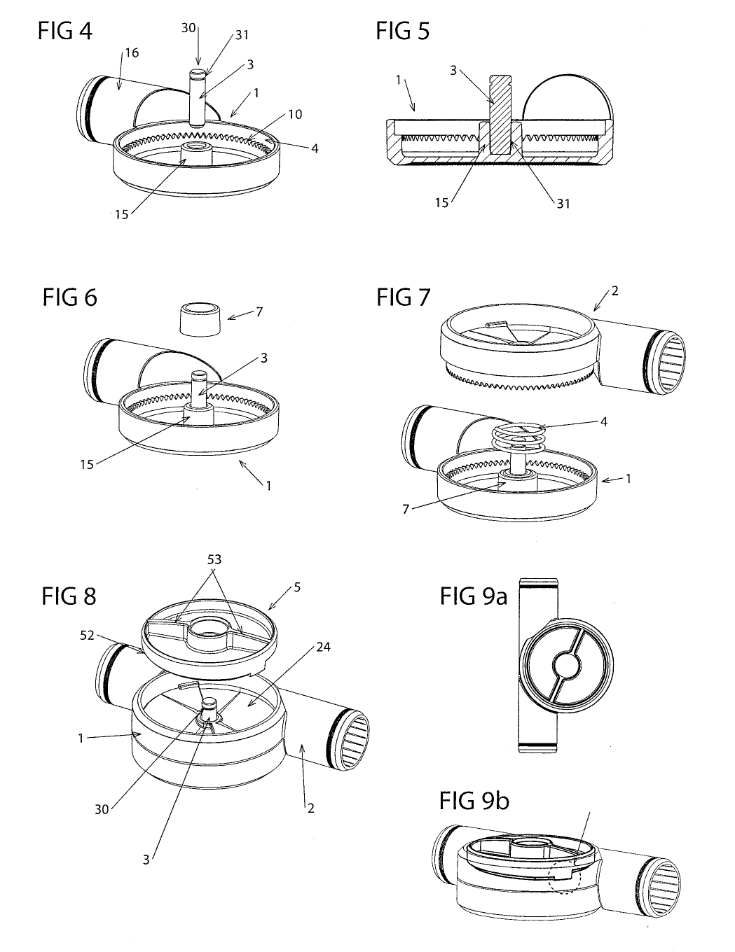

As can best be seen by FIG. 4, the free end 30 of the axle rod 3 extends beyond the outer face 24 of the second body 2. The cam element 5 is then placed into the cavity defined by the outer face 24 and the second circular flange 26 and, in this position, the free end 30 of the axle rod 3 is located within the cam hole 54.

The washer 8 is then inserted onto the axle rod 3 by passing it over the free end 30 of the axle rod 3. The circlip 6 is then positioned by inserting a portion of the circlip 6 into the angular groove 31 on the axle rod 3. When in this position, the circlip 6 prevents any lateral movement beyond this circlip of the cam 5 and/or the second body 2.

The cap 9 can then be attached by inserting the skirt 91 into the cam hole 54.

The first body 1 and the second body 2 are intended to be connected to poles, arms, legs or similar extensions by connecting these extensions to the arm connection sleeves 16, 28.

In the alternative preferred embodiment shown in FIGS. 2 and 2A, the arrangement is much the same, save that the axle rod 3a in molded into the first body 1. As is apparent from the above, in this alternative preferred embodiment, the lock nut 6a is used instead of a circlip. Also, the washer 8a, which contains the nipple 81, replaces the washer 8 and the nipple 81 is positioned within the longitudinal groove 33 of the axle rod 3a.

The hinge joint assembly described above functions as a very convenient and usable quick release and quick locking hinge joint. It therefore has potential application to a significant number of products, such as outdoor umbrellas, lamp stands, extension arms for computer monitors and other products.

Wherever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A hinge joint assembly including:
a first body having a first circular serrated edge located around a first central axis;
a second body having a second circular serrated edge located around a second central axis, said second circular serrated edge corresponding with and adapted to engage with the first circular serrated edge;
an axle rod, extending through the first central axis and the second central axis, adapted to enable the first and second bodies to rotate relative to one another;
biasing means, positioned between the first body and the second body, for biasing said first and second bodies away from each other along the axle rod;
movement limiting means for preventing the second body from being separated from the first body, under the influence of the biasing means, beyond a pre-determined distance; and
a cam element, rotatable about the axle rod, adapted to move the second body relative to the first body, from a joint locked position to a joint unlocked position, as the cam element is rotated from a first angular position to a second angular position.

2. A hinge joint assembly according to claim 1, wherein each of the first and second circular serrated edges comprise a plurality of teeth of substantially uniform height and dimensions, and the pre-determined distance is no less than the height of the teeth.

3. A hinge joint assembly according to claim 1, wherein the axle rod is fixedly secured to the first body and the second body is rotatable about the axle rod.

4. A hinge joint assembly according to claim 3, wherein:
the second body comprises an inner face facing towards the first body and an outer face facing away from the first body;
the cam element comprises a cam face which abuts the outer face of the second body;
at least one of the outer face and the cam face has an inclined surface; and
the outer face and the cam face are adapted to cause the second body to move relative to the first body as the cam element is rotated relative to the second body.

5. A hinge joint assembly according to claim 4, wherein the cam face comprises a protrusion extending outwardly from the cam face and the outer face of the second body comprises a ramped surface which inclines between a first point and a second point angularly separated from the first point.

6. A hinge joint assembly according to claim 5, wherein both the cam face and the outer face of the second body comprise ramped surfaces, which incline between a first point and a second point on each face, each of said second points being angularly separated from the corresponding first point.

7. A hinge joint assembly according to claim 3, wherein the movement limiting means comprises a protruding element extending from the axle rod adjacent a free end of the axle rod.

8. A hinge joint assembly according to claim 7, wherein the protruding element comprises a circlip, an inner edge of which is seated in a groove about the circumference of the axle rod adjacent to the cam element.

9. A hinge joint assembly according to claim 8, wherein the assembly further comprises a washer positioned between the circlip and the cam element.

10. A hinge joint assembly according to claim 7, wherein the free end of the axle rod is threaded and the protruding element comprises a nut located about the threaded free end of the axle rod.

11. A hinge joint assembly according to claim 10, further comprising a washer positioned between the nut and the cam element, wherein:
the washer includes an inner circumference and an outer circumference, said inner circumference having a small nipple protruding inwardly from the inner circumference; and
the free end of the axle rod includes a longitudinal groove adapted to receive the nipple of the washer.

12. A hinge joint assembly according to claim 1, wherein the first body comprises a circular base portion and a first circular flange extending upwardly from a perimeter of the circular base portion and wherein the first circular serrated ridge is located on an inner wall of said first circular flange.

13. A hinge joint assembly according to claim 12, wherein, when the second circular serrated ridge is engaged with the first circular serrated ridge, the second circular serrated ridge is located within said first circular flange.

14. A hinge joint assembly according to claim 1, wherein the cam element further comprises an operational face having finger engagement means for facilitating a user's fingers to engage therewith in order to rotate the cam.

15. A hinge joint assembly according to claim 1, wherein the second body comprises a second circular flange extending upwardly from a perimeter of the outer face and the cam element is located within a cavity defined by the outer face and the second circular flange.

16. A hinge joint assembly according to claim 1, wherein the biasing means comprises a coil spring positioned around the axle rod.

17. A hinge joint assembly according to claim 16, wherein a first end of the coil spring abuts the circular base portion of the first body and a second end of the spring abuts the inner face of the second body.

18. A hinge joint assembly according to claim 4, wherein the second body further includes a cylindrical sleeve extending from the inner face adjacent the second central axis, said cylindrical sleeve being located about said axle rod.

19. A hinge joint assembly according to claim 18, further including a bush piece positioned intermediate the axle rod and the cylindrical sleeve.

20. A hinge joint assembly according to claim 3, wherein the axle rod is molded into the first body.

21. A hinge joint assembly according to claim 3, wherein the axle rod is fixedly secured to the first body by means of axle rod affixing means.

22. A hinge joint assembly according to claim 21, wherein the axle rod affixing means comprises a mounting sleeve extending axially from the circular base portion of the first body, said mounting sleeve adapted to receive a securing end of the axle rod.

23. A hinge joint assembly according to claim 22, wherein the securing end of the axle rod is securely affixed within the mounting sleeve by means of an interference fit.

24. A hinge joint assembly according to claim 22, wherein the securing end of the axle rod is securely affixed within the mounting sleeve by a strong adhesive.

25. A hinge joint assembly according to claim 22, wherein the bush piece is positioned intermediate the mounting sleeve of the first body and the cylindrical sleeve of the second body.

26. A hinge joint assembly according to claim 1, wherein the first body includes first connection means for joining said first body to a first object and the second body includes second connection means for joining said second body to a second object.

27. A hinge joint assembly according to claim 26, wherein the first and second objects are trunk sections of an outdoor umbrella.

28. A bendable article comprising a first arm, a second arm and a hinge joint assembly according to claim 1, said hinge joint assembly being positioned between and connected to said first and second arms.

29. A bendable article according to claim 28, wherein said article is an outdoor umbrella.

30. An outdoor umbrella, comprising a trunk leg, a movable arm and a hinge joint assembly according to claim 1, wherein said hinge joint assembly is positioned between and connected to the trunk leg and the moveable arm.

31. An outdoor umbrella, according to claim 30, wherein a free end of the trunk leg comprises ground engaging means.

32. An outdoor umbrella, according to claim 31, wherein the ground engaging means is comprises a metal tip having a sharpened end and an external threaded surface extending from the sharpened end.
